(19) United States
(12) Patent Application Publication
(10) Pub. No.: US 2018/0319634 A1
(43) Pub. Date: Nov. 8, 2018

(54) CRANE HYDRAULIC SYSTEM AND CONTROLLING METHOD OF THE SYSTEM

(71) Applicant: XUZHOU HEAVY MACHINERY CO., LTD., Xuzhou City, Jiangsu Province (CN)

(72) Inventors: Zenghai Shan, Xuzhou City (CN); Xiaodong Hu, Xuzhou City (CN); Guowang Jiao, Xuzhou City (CN); Bin Zhou, Xuzhou City (CN); Conglin Yuan, Xuzhou City (CN)

(21) Appl. No.: 15/522,105

(22) PCT Filed: Oct. 30, 2015
(86) PCT No.: PCT/CN2015/009329

§ 371 Date: Mar. 7, 2018

(30) Foreign Application Priority Data
Oct. 30, 2014 (CN) 201410599098.7
Nov. 24, 2014 (CN) 201410680616.8
Nov. 24, 2014 (CN) 201410681368.9
Jan. 23, 2015 (CN) 201510035658.0

(51) Int. Cl. B66C 13/20; B66D 1/08; F15B 11/08; F15B 13/16; F15B 13/04

(52) U.S. Cl. CPC B66C 13/20; B66D 1/08; F15B 13/0417; F15B 13/16; F15B 11/08

(57) ABSTRACT

The present application relates to a crane hydraulic system and a controlling method of the system, wherein the crane hydraulic system includes a load sensing subsystem, and the subsystem includes a variable pump, a variable pump oil inlet line, a load feedback line, an oil return line and a pressure compensator; the pressure compensator is provided with an oil inlet, an oil outlet, a first control oil port, a second control oil port and a control spring; the oil inlet communicates with the variable pump oil inlet line, the oil outlet communicates with the oil return line, the first control oil port communicates with the load feedback line, and the second control oil port also communicates with the variable pump oil inlet line; and wherein the control spring and the first control oil port are located on the same end of the pressure compensator, and a set pressure of the control spring is greater than a pressure difference of the variable pump. According to the present application, since the load sensing subsystem is arranged, at the start and stop moments of a winch system, the pressure compensator can be opened, and the variable pump oil inlet line communicates with the oil return line to realize pressure relief, so as to reduce the pressure impact.

### FIELD OF THE INVENTION

The present application relates to the field of hydraulic technology, and in particular to a crane hydraulic system and a controlling method of the system.

### BACKGROUND OF THE INVENTION

A variable pump load sensing system is widely used in the design of mobile cranes because of its higher comprehensive performance. The system can feed back a pressure signal necessary for a load to a variable pump, the variable pump automatically adjusts the swinging angle of a swash plate to change the displacement, so that the output by the pump is consistently matched with the necessary flow of the system to avoid excessive overflow loss, and the energy saving performance is good. The existing variable pump load sensing system mainly adopts a control mode of a variable displacement piston pump and an independent flow distribution (LUDV) main valve. With the development of engineering machinery, higher requirements on the operability and the rapidity of cranes are put forward. The aforementioned control mode still has certain shortcomings on micro moving performance of winch, efficiency of boom down by derricking mechanism, and simultaneous action performance of derricking mechanism and winch, which are mainly embodied in the following four aspects:

1. High Pressure Impact in Start and Stop Operations of Winch

Since in a middle position of valve a P port of the load sensing system is closed, in valve port opening and closing phases of the valve, the valve port is suddenly communicated with the load oil source or is interrupted from the load oil source, and due to the inertia effect during the start and stop operations of a winch, the system inevitably has pressure impact. The impact will influence the smoothness of the winch system, which is mainly embodied in the following two aspects:

(1) at the beginning of weight down driven by the winch, an opening control pressure of a balance valve is derived from a down port of a motor, resulting in a large opening of the balance valve, so that a weight accelerates to down; due to the sudden down, the flow in an oil inlet cannot meet the down speed at the moment, the motor is subjected to temporary empty suction, the valve port of the balance valve is closed instantly, and the representation on manipulation lies in that the weight downs suddenly and stops suddenly to generate larger jitter.

(2) In stop of winch, the high pressure impact will influence the closing time of a brake, resulting in mismatch of brake control and system manipulation, and generating friction, abnormal sound and other phenomena. At present, to reduce the influence of the pressure impact on the smoothness of the winch system, a complex balance valve control port cover needs to be designed in general, which increases the design cost, and can relieve the influence of the pressure impact on the manipulation to a certain extent, but cannot fundamentally reduce the pressure impact.

2. Composite Action Problem of Winch and Derricking Mechanism Under Large Load Deviation Working Condition

With the development of engineering machinery, higher requirements on the operability and the rapidity of cranes are put forward. On modern crane, an independent flow distribution (LUDV) control technology is often applied to a crane hydraulic system. The main principle of the independent flow distribution control technology is that with maximum load pressures of actuators as reference, when the necessary flow of the actuators is greater than the flow of the pump, the system will allocate the flow to the actuators according to a proportion, instead of flowing to light-load actuators.

According to the independent flow distribution control technology, when a composite action is carried out, under a larger load pressure difference working condition, it is very difficult to allocate the flow to the actuators according to an certain proportion, some actuators are subjected to insufficient oil supply, thereby producing a composite action failure phenomenon, which brings great inconvenience to the use of users.

3. Contradiction of Synchronous Improvement of Smoothness and Working Efficiency of Boom Down

There are two boom down control methods of cranes at present. The first method is a power down control method. In the first method the opening control pressure of the balance valve is directly derived from a rod cavity, the size of the opening of the balance valve is controlled by controlling the pressure and the flow of an oil source to control the boom down speed. In this method, the boom down speed is higher, but the size of the opening of the balance valve is greatly influenced by the boom down load, therefore the stability and the smoothness are worse, and the boom is easy to jitter during downing. The second method is a gravity down control method. In the second method, the opening control pressure of the balance valve is derived from an external pilot oil source, a piston rod of an cylinder downs by self gravity, and the opening of the balance valve is controlled by the external oil source to control the down speed. In the method, the control pressure of the balance valve is not influenced by the fluctuation of the load pressure, therefore the down process is stable, but the down speed is low. Since the gravity down control method has higher micro moving performance and stability, cranes adopting pilot control basically use the gravity down control method at present. However, the second method also has defects: an oil supply speed is invariable, the boom down speed is low, particularly in the case of full retraction of the boom, the boom down time is longer than 120 seconds (boom up time is generally less than 60 seconds), thereby seriously influencing the working efficiency of the cranes, and thus the user complaints are numerous.

4. The Composite Action of Telescoping Mechanism and Auxiliary Winch of the Cranes Cannot be Carried Out, and Unloading is Insufficient.

The crane generally has five basic actions: action of main winch, action of auxiliary winch, derricking, telescoping and slewing. In a practical use process, the composite actions of boom extension and hook down by the auxiliary winch are carried out at the same time, or the composite actions of the boom retraction and hook up by the auxiliary winch are carried out at the same time, which are common manipulation working conditions of the users. In the existing hydraulic system, a four-position two-way solenoid valve is generally adopted to carry out action switching control of telescoping mechanism and auxiliary winch, but the boom extension and the hook down by auxiliary winch cannot be controlled at the same time, the boom retraction and hook up by the auxiliary winch cannot be controlled at the same time neither, that is, the control of the composite actions of the boom telescoping and hook up or down by the auxiliary winch cannot be realized, which brings inconvenience to user operations.

In addition, the existing control method adopts a parallel unloading mode. When an unloading solenoid valve is energized, a part of hydraulic oil controlled by a handle flows back to an oil tank, a part can still enter an auxiliary winch pilot control cavity or a telescopic pilot control cavity, resulting in a problem of insufficient unloading and action residue; and moreover, a cross connection of oil passages exists between the pilot control cavities, thus oil mixing is likely to occur to result in a malfunction phenomenon.

### SUMMARY OF THE INVENTION

An object of the present application is to provide a crane hydraulic system and a controlling method of the method, in order to fundamentally reduce impact in start and stop operations of a load sensing winch system.

To achieve the aforementioned object, the present application provides a crane hydraulic system, including a load sensing subsystem, wherein the load sensing subsystem includes a variable pump, a variable pump oil inlet line, a load feedback line, an oil return line and a pressure compensator; wherein, the pressure compensator is provided with an oil inlet, an oil outlet, a first control oil port, a second control oil port and a control spring;

the oil inlet communicates with the variable pump oil inlet line, the oil outlet communicates with the oil return line, the first control oil port communicates with the load feedback line, and the second control oil port communicates with the variable pump oil inlet line; and

wherein the control spring and the first control oil port are located on the same end of the pressure compensator, and a set pressure of the control spring is greater than a pressure difference of the variable pump.

To achieve the aforementioned object, the present application further provides a controlling method of the aforementioned crane hydraulic system, including the following steps:

setting an opening pressure of the pressure compensator of the load sensitive subsystem connected with a winch system greater than a difference between a variable pump pressure and a load pressure of the load sensing subsystem; and starting the winch system.

To achieve the aforementioned object, the present application further provides a controlling method of the aforementioned crane hydraulic system, including the following control process:

when a control pressure output by a first load pressure source to a hydraulic operated port of a hydraulic operated reversing valve is zero, and when a solenoid valve is de-energized, the hydraulic operated reversing valve resets, a load oil source of a second load pressure source is interrupted from a shuttle valve by the hydraulic operated reversing valve, meanwhile the control pressure oil of a control pressure source is blocked and is interrupted from the shuttle valve, the control pressure output by the shuttle valve to a control port of a confluence valve is zero, the confluence valve is at an upper position, and a first main pump and a second main pump are in a confluence state at the moment;

when the solenoid valve is energized, the control pressure oil of the control pressure source communicates with the shuttle valve through the solenoid valve, the control pressure output by the shuttle valve enters the control port of the confluence valve, the confluence valve is at a lower position, and the first main pump and the second main pump are cut off by the confluence valve and are in a non-confluence state at the moment; and

when a composite action is carried out, the load pressure of the first load pressure source acts on the hydraulic operated port of the hydraulic operated reversing valve to cause the hydraulic operated reversing valve to work at a left position, the second load pressure source communicates with the shuttle valve through the left position of the hydraulic operated reversing valve and load pressure of the second load pressure source acts on the control port of the confluence valve through the shuttle valve at the moment, when the load pressure of the second load pressure source is increased to be large enough to overcome a force of a reversing spring of the confluence valve, the confluence valve reverses, and the first main pump and the second main pump change from the confluence state into the non-confluence state.

To achieve the aforementioned object, the present application further provides a controlling method of the aforementioned crane hydraulic system, including: when a first control solenoid valve, a second control solenoid valve, a third control solenoid valve and a fourth control solenoid valve are all de-energized, controlling a handle to supply oil to a first output oil passage, so that hydraulic oil simultaneously enters a first control cavity of a first proportional reversing valve and a first control cavity of a second proportional reversing valve, in order to drive a first executive element to execute a first action and drive a second executive element to execute a second action at the same time; and

when the first control solenoid valve, the second control solenoid valve, the third control solenoid valve and the fourth control solenoid valve are all de-energized, controlling the handle to supply oil to a second output oil passage, so that the hydraulic oil simultaneously enters a second control cavity of the first proportional reversing valve and a second control cavity of the second proportional reversing valve, in order to drive the first executive element to execute a third action and drive the second executive element to execute a fourth action at the same time.

Further, the aforementioned control method further includes:

when the first control solenoid valve and the fourth control solenoid valve are de-energized, and the second control solenoid valve and the third control solenoid valve are energized, controlling the handle to supply oil to the first output oil passage, so that the hydraulic oil enters the first control cavity of the first proportional reversing valve to drive the first executive element to execute the first action; controlling the handle to supply oil to the second output oil passage, so that the hydraulic oil enters the second control cavity of the first proportional reversing valve to drive the first executive element to execute the third action;

when the second control solenoid valve and the third control solenoid valve are de-energized, and the first control solenoid valve and the fourth control solenoid valve are energized, controlling the handle to supply oil to the first output oil passage, so that the hydraulic oil enters the first control cavity of the second proportional reversing valve to drive the second executive element to execute the second action; controlling the handle to supply oil to the second output oil passage, so that the hydraulic oil enters the second control cavity of the second proportional reversing valve to drive the second executive element to execute the fourth action.

Based on the aforementioned technical solutions, the crane hydraulic system of the present application includes the load sensing subsystem, and the set pressure of the control spring is greater than the pressure difference of the variable pump. During normal work of the winch system where the load sensing subsystem is located, the pressure compensator is in an ordinary state, namely in an off state. At the moment, the pressure compensator will not influence the working states of other components in the load sensing subsystem. At the opening and closing moments of the winch system, the pressure in the variable pump oil inlet line will be increased instantly, so that the pressure difference between the variable pump oil inlet line and the load feedback line is greater than the set pressure of the control spring, the pressure compensator is opened to communicate the variable pump oil inlet line with the oil return line to realize pressure relief, and thus the pressure impact is reduced.

### BRIEF DESCRIPTION OF THE DRAWINGS

FIG. 1 is a schematic principle diagram of one embodiment of a load sensing subsystem in the present application.

FIG. 2 is a pressure change curve of a variable pump in one embodiment of a load sensing subsystem in the present application.

FIG. 3 is a schematic principle diagram of one embodiment of a confluence control subsystem in the present application.

FIG. 4 is a schematic principle diagram of one application embodiment of a confluence control subsystem in the present application.

FIG. 5 is a schematic principle diagram of another application embodiment of the confluence control subsystem in the present application.

FIG. 6 is a schematic diagram of switching an cylinder down control valve provided by a preferred implementation of an embodiment of the present application from an initial position to a first position and switching the same from the first position to a second position.

FIG. 7 is a schematic diagram of switching a reversing valve provided by a preferred implementation of an embodiment of the present application from a middle position to a first position and switching the same from the first position to a second position.

FIG. 8 is a schematic diagram of one embodiment of a composite action control subsystem in the present application.

### DETAILED DESCRIPTION OF THE EMBODIMENTS

A further detailed description of the technical solutions of the present application will be given below through the accompany drawings and embodiments.

According to one aspect of the present application, in order to solve the problem of high pressure impact in start and stop operations of a winch system, the present application provides a crane hydraulic system at first. The crane hydraulic system includes a load sensing subsystem, and a set pressure of a control spring thereof is greater than a pressure difference of a variable pump. During normal work of a winch system where the load sensing subsystem is located, a pressure compensator is in an ordinary state, namely in an off state. At the moment, the pressure compensator will not influence the working states of other components in the load sensing subsystem. At the opening and closing moments of the winch system, the pressure in a variable pump oil inlet line will be increased instantly, so that the pressure difference between the variable pump oil inlet line and a load feedback line is greater than the set pressure of the control spring, the pressure compensator is opened to communicate the variable pump oil inlet line with an oil return line to realize pressure relief, and thus the pressure impact is reduced.

Specific structures of various embodiments of the load sensing subsystem will be specifically introduced below.

As shown in FIG. 1, the embodiment of the present application provides a load sensing subsystem, including: a variable pump 1-1, a variable pump oil inlet line 1-2, a load feedback line 1-3, an oil return line 1-4 and a pressure compensator 1-5. The pressure compensator 1-5 is provided with an oil inlet 1-51, an oil outlet 1-52, a first control oil port 1-53, a second control oil port 1-54 and a control spring 1-55. The oil inlet 1-51 communicates with the variable pump oil inlet line 1-2, the oil outlet 1-52 communicates with the oil return line 1-4, the first control oil port 1-53 communicates with the load feedback line 1-3, and the second control oil port 1-54 communicates with the variable pump oil inlet line 1-2. The control spring 1-55 and the first control oil port 1-53 are located on the same end of the pressure compensator 1-5, and a set pressure of the control spring 1-55 is greater than a pressure difference of the variable pump 1-1.

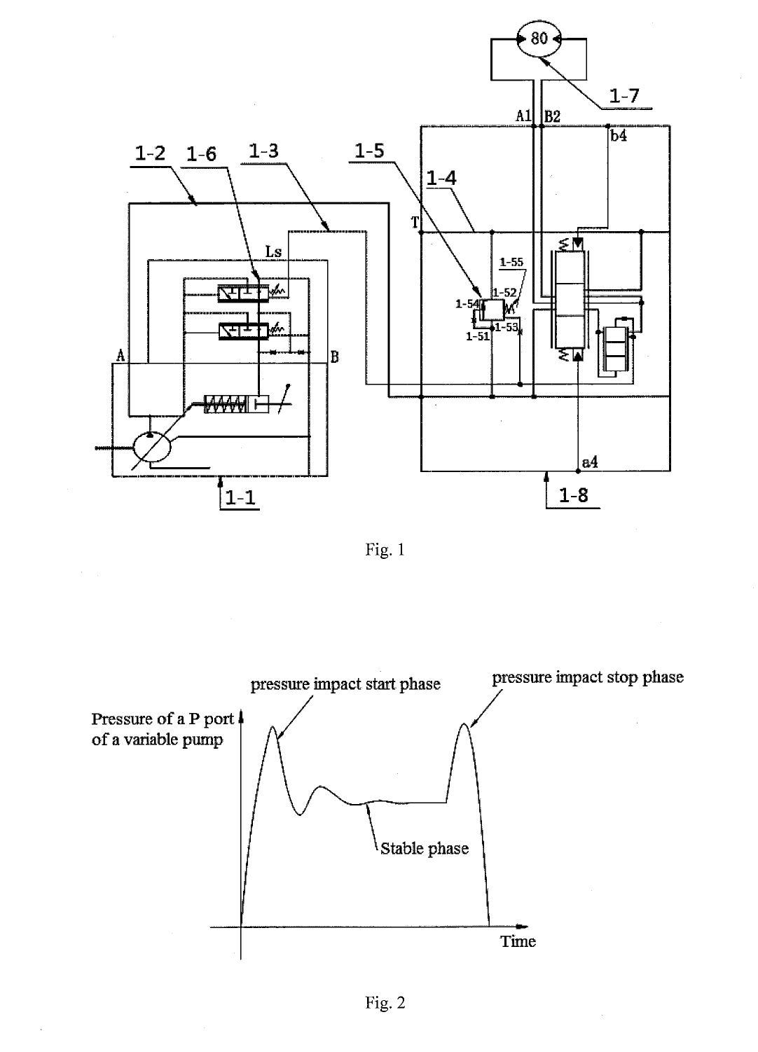

The pressure difference of the variable pump 1-1 refers to the pressure difference between the variable pump oil inlet line 1-2 and the load feedback line 1-3 during normal work (corresponding to a stable phase in FIG. 2). In the aforementioned load sensing subsystem, the set pressure of the control spring 1-55 is greater than the pressure difference of the variable pump 1-1. During normal work of the winch system where the load sensing subsystem is located, the pressure compensator 1-5 is in the ordinary state, namely in the off state. At the moment, the pressure compensator 1-5 will not influence the working states of other components in the load sensing subsystem. At the starting and closing moments (corresponding to a pressure impact start phase and a pressure impact stop phase in FIG. 2) of the winch system, the pressure in the variable pump oil inlet line 1-2 will be increased instantly, so that the pressure difference between the variable pump oil inlet line 1-2 and the load feedback line 1-3 is greater than the set pressure of the control spring 1-55, the pressure compensator 1-5 is opened to communicate the variable pump oil inlet line 1-2 with the oil return line 1-4 through the pressure compensator 1-5 to realize pressure relief, so as to fundamentally reduce the pressure impact, and the pressure impact can even be eliminated.

The pressure compensator 1-5 is mounted in the aforementioned load sensing subsystem. When the winch system normally works, the set pressure of the control spring 1-55 is greater than the pressure difference of the variable pump 1-1, the pressure compensator is in an off state, and oil flow of the winch system is not bypassed by the compensator. When the pressure impact is too large at the start and stop moments of the winch system, the pressure compensator 1-5 is opened to bypass the oil flow, high pressure oil in a P port of the variable pump relieves pressure instantly, so that the pressure impact is reduced, and the operation smoothness of the system is improved.

Further, the control spring 1-55 is an adjustable spring. The opening pressure of the pressure compensator 1-5 can be set by the spring.

Herein, the pressure compensator 1-5 can be a three-way pressure compensator. According to the load sensing subsystem provided by the aforementioned technical solution, the pressure compensator 1-5 is added. The pressure compensator 1-5 has three ways, which are respectively connected with the load feedback line 1-3, the variable pump oil inlet line 1-2 and the oil return line 1-4. The pressure compensator 1-5 is provided with the adjustable spring for adjusting an opening pressure difference ΔP of the pressure compensator 1-5, for example, when the adjustable spring is adjusted and the opening pressure difference ΔP is 30 bar, the difference between the pressure of the P port of the variable pump and the load pressure needs to be greater than 30 bar, the pressure compensator 1-5 can be opened to bypass the oil flow and can relieve the pressure, and otherwise the pressure compensator 1-5 is in the off state. A variable pump pressure difference control valve 1-6 is used for setting the difference ΔP1 between the pressure of the P port of the variable pump and the load pressure during normal work. The opening pressure difference ΔP of the pressure compensator 1-5 is set to be greater than the pressure difference of the load sensing variable pump 1-1 in the present application, and the pressure compensator 1-5 will not be opened when the system is normal. At the start and stop moments of the system, the pressure compensator 1-5 is opened to reduce the impact of the winch system. The load sensing subsystem feeds back a load pressure signal to the hydraulic system, and the system can automatically adjust pressure and flow parameters to meet the working demands of the system.

The three-way pressure compensator 1-5 has three oil ports and can automatically adjust the bypassed oil flow of the system according to the load pressure to adapt to the load demands.

The working process of the aforementioned load sensing subsystem is as follows.

A winch motor 1-7 is connected with a main valve 1-8. When the winch motor 1-7 starts, the main valve 1-8 feeds back the pressure of the motor to the variable pump 1-1 through the load feedback line 1-3, and, at this time, the variable pump 1-1 automatically adjusts the displacement. With the increase of the displacement, the pressure of the P port of the variable pump is increased accordingly. When the pressure of the P port of the variable pump is increased to make the difference between the pressure of the P port of the variable pump and the load pressure become the difference ΔP1, the increase of the displacement of the variable pump is stopped. A change process curve of the pressure of the P port of the variable pump is shown in FIG. 2. In start and stop phases of the system, the fluctuation of the pressure of the P port of the variable pump is greater, and the pressure compensator 1-5 will be opened in the two phases to reduce the impact of the system. After the system is stable, the pressure of the P port of the variable pump=the load pressure+the difference ΔP1. Since ΔP>ΔP1, the pressure compensator 1-5 cannot be opened, so the normal operation of the system is not influenced. Before the system is stable, a larger pressure impact and a overshooting in the P port of the variable pump are generated, in the case that the pressure of the P port of the variable pump—the load pressure >ΔP, a valve rod of the pressure compensator 1-5 reverses, the P port of the variable pump directly communicates with the oil return port, the pressure of the P port is reduced instantly, and thus overlarge impact can be prevented.

Similarly, when the winch motor 1-7 stops, since the middle position of the valve rod controlling the variable pump 1-1 is closed, the flow adjustment of the variable pump 1-1 lags behind the adjustment of the valve rod, so the pressure impact will be generated as well, and the pressure compensator 1-5 can also be opened to bypass and unload to reduce the impact.

The load sensing subsystem provided by the aforementioned technical solution can fundamentally reduce the pressure impact of the winch system in start and stop operations and improve the smoothness of the winch system, moreover, no special design needs to be carried out on the control port cover of the balance valve, thereby reducing the system cost and facilitating the maintenance.

The embodiment of the present application further provides an anti-impact control method for the winch system, and the method is preferably implemented by the load sensing subsystem provided by the aforementioned embodiment of the present application. The method includes the following steps:

setting an opening pressure of the pressure compensator 1-5 of the load sensing subsystem connected with the winch system, and making the opening pressure of the pressure compensator 1-5 be greater than a difference between a variable pump pressure and a load pressure of the load sensing subsystem; and starting the winch system.

Further, the setting an opening pressure of the pressure compensator 1-5 of the load sensing subsystem connected with the winch system, and making the opening pressure of the pressure compensator 1-5 be greater than a difference between a variable pump pressure and a load pressure of the load sensing subsystem includes: communicating the oil inlet 1-51 of the pressure compensator 1-5 with the variable pump oil inlet line 1-2 of the load sensing subsystem, communicating the oil outlet 1-52 of the pressure compensator 1-5 with the oil return line 1-4 of the load sensing subsystem, communicating the first control oil port 1-53 of the pressure compensator 1-5 with the load feedback line 1-3, and communicating the second control oil port 1-54 of the pressure compensator 1-5 with the variable pump oil inlet line 1-2 as well, wherein the control spring 1-55 and the first control oil port 1-53 are located on the same end of the pressure compensator 1-5, and the set pressure of the control spring 1-55 is greater than the pressure difference of the variable pump 1-1.

As mentioned above, the control spring 1-55 is an adjustable spring.

Preferably, the pressure compensator 1-5 is a three-way pressure compensator. According to another aspect of the present application, in order to solve the composite action problem of a winch and derricking mechanism in large load deviation working condition, the crane hydraulic system of the present application can further include a confluence control subsystem. Automatic control and manual control of confluence of two pumps can be realized by control logic composed of a solenoid valve, a hydraulic operated reversing valve and a shuttle valve, and thus the working rapidity and reliability of the crane are improved. During the composite action, when the load pressure difference is increased to a certain extent, a two pump confluence state can be automatically switched to a non-confluence state in which two pumps independently supply oil and generate no mutual influences on the performance, and the effect of the composite action is improved. By means of a manual confluence control mechanism of two pumps, the two pumps can separately work according to the demands of actual working conditions, for example, the two pumps separately work in the case of winch micro moving, boom down, boom telescoping, and other operations, so as to improve the micro moving performance and reduce the power consumption.

Specific structures of various embodiments of the confluence control subsystem will be specifically introduced below:

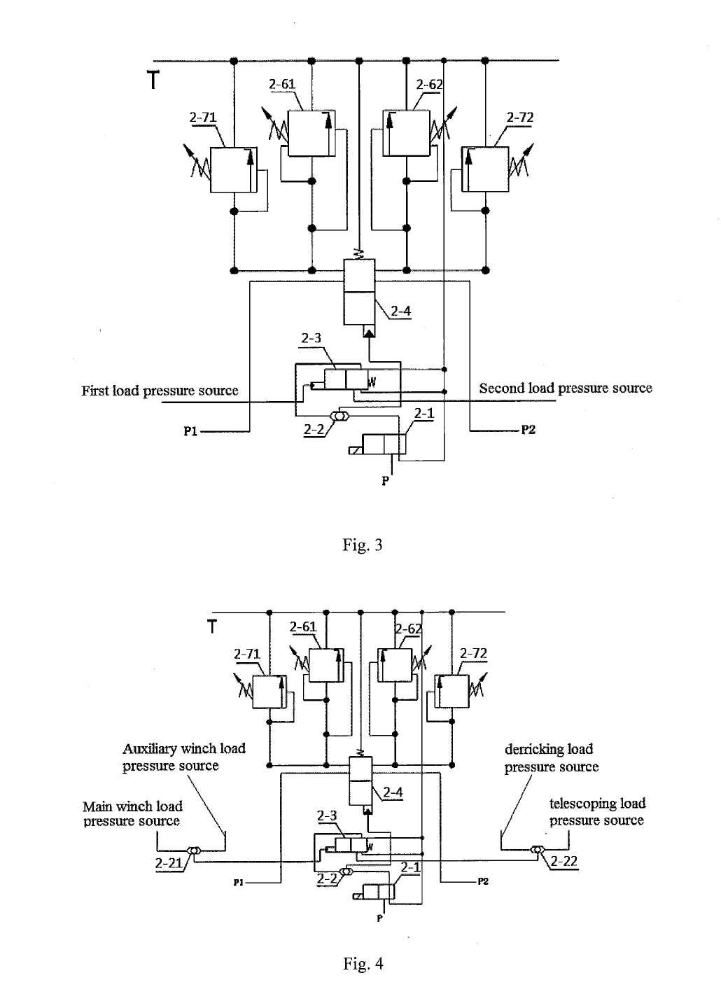

FIG. 3 is a schematic principle diagram of one embodiment of the confluence control subsystem in the present application. Referring to FIG. 3, the confluence control subsystem of the embodiment includes: a solenoid valve 2-1, a shuttle valve 2-2, a hydraulic operated reversing valve 2-3 and a confluence valve 2-4. The confluence control subsystem mainly carries out logic control on the pilot oil of the confluence valve 2-4 by the solenoid valve 2-1 and the hydraulic operated reversing valve 2-3 via the shuttle valve 2-2 to realize the confluence control of a first main pump P1 and a second main pump P2. The oil inlet of the solenoid valve 2-1 communicates with a control pressure source P. The first oil inlet of the shuttle valve 2-2 communicates with a working oil port of the hydraulic operated reversing valve 2-3, the second oil inlet of the shuttle valve 2-2 communicates with the working oil port of the solenoid valve 2-1, and the oil outlet of the shuttle valve 2-2 communicates with a control port of the confluence valve 2-4. A hydraulic operated port of the hydraulic operated reversing valve 2-3 communicates with at least one first load pressure source, and the oil inlet of the hydraulic operated reversing valve 2-3 communicates with at least one second load pressure source. A first oil port of the confluence valve 2-4 communicates with the first main pump P1, and a second oil port of the confluence valve 2-4 communicates with the second main pump P2. After the solenoid valve 2-1 is energized, the oil inlet of the solenoid valve 2-1 communicates with the working oil port of the solenoid valve 2-1, and after the solenoid valve 2-1 is de-energized, the working oil port of the solenoid valve 2-1 communicates with an oil return port. After the hydraulic operated reversing valve 2-3 reverses through the hydraulic operated port, the oil inlet of the hydraulic operated reversing valve 2-3 communicates with the working oil port of the hydraulic operated reversing valve 2-3, and after the hydraulic operated reversing valve 2-3 resets, the working oil port of the hydraulic operated reversing valve 2-3 communicates with the oil return port. T represents the oil return port.

The confluence control subsystem can further include a first constant difference flow valve 2-61 and a second constant difference flow valve 2-62. The oil inlet of the first constant difference flow valve 2-61 communicates with a third oil port of the confluence valve 2-4, and the oil outlet of the first constant difference flow valve 2-61 communicates with an oil tank. The oil inlet of the second constant difference flow valve 2-62 communicates with a fourth oil port of the confluence valve 2-4, and the oil outlet of the second constant difference flow valve 2-62 communicates with the oil tank. A small bypass flow can be provided by setting the constant difference flow valves to unload the pressure of the load feedback oil line in time at the end of the operation, so as to eliminate the pressure fluctuation brought by sudden confluence of the two pumps and improve the confluence stability.

The confluence control subsystem can further include a first overflow valve 2-71 and a second overflow valve 2-72. The oil inlet of the first overflow valve 2-71 communicates with the third oil port of the confluence valve 2-4, and the oil outlet of the first overflow valve 2-71 communicates with the oil tank. The oil inlet of the second overflow valve 2-72 communicates with the fourth oil port of the confluence valve 2-4, and the oil outlet of the second overflow valve 2-72 communicates with the oil tank. The maximum pressure of the load feedback oil line can be limited by setting the overflow valves to maintain the working pressures of the hydraulic oil pumps. In the confluence control subsystem, a throttle orifice can be arranged in a pilot oil passage of the confluence valve 2-4 to increase the pressure control stability of the confluence valve and guarantee smooth reversing of the confluence valve, so as to eliminate the pressure impact.

During a crane operation, for example, a typical composite action is the composite action of main/auxiliary winch and derricking mechanism, the composite action of main/auxiliary winch and telescoping mechanism, and the like. Therefore, for example, the first/second load pressure source includes, but not limited to, a main winch load pressure source, an auxiliary winch load pressure source, an derricking load pressure source, an telescoping load pressure source, and the like. Moreover, there is more than one first load pressure source or second load pressure source, the logic relationship of the load pressure sources of the confluence control subsystem can be achieved by the shuttle valve or a check valve to be “or”, which will be respectively illustrated below.

Referring to FIG. 4, a first shuttle valve 2-21 is arranged on an oil line communicating the hydraulic operated port of the hydraulic operated reversing valve 2-3 and the first load pressure source. The oil inlet of the first shuttle valve 2-21 communicates with the first load pressure source, and the oil outlet of the first shuttle valve 2-21 communicates with the hydraulic operated port of the hydraulic operated reversing valve 2-3. A second shuttle valve 2-22 is arranged on an oil line communicating the oil inlet of the hydraulic operated reversing valve 2-3 and the second load pressure source. The oil inlet of the second shuttle valve 2-22 communicates with the second load pressure source, and the oil outlet of the second shuttle valve 2-22 communicates with the oil inlet of the hydraulic operated reversing valve 2-3. It is taken as an example that the first load pressure source includes the main winch load pressure source and the auxiliary winch load pressure source and that the second load pressure source includes the derricking load pressure source and the telescoping load pressure source, two oil inlets of the first shuttle valve 2-21 respectively communicate with the main winch load pressure source and the auxiliary winch load pressure source, and the two oil inlets of the second shuttle valve 2-22 respectively communicate with the derricking load pressure source and the telescoping load pressure source.

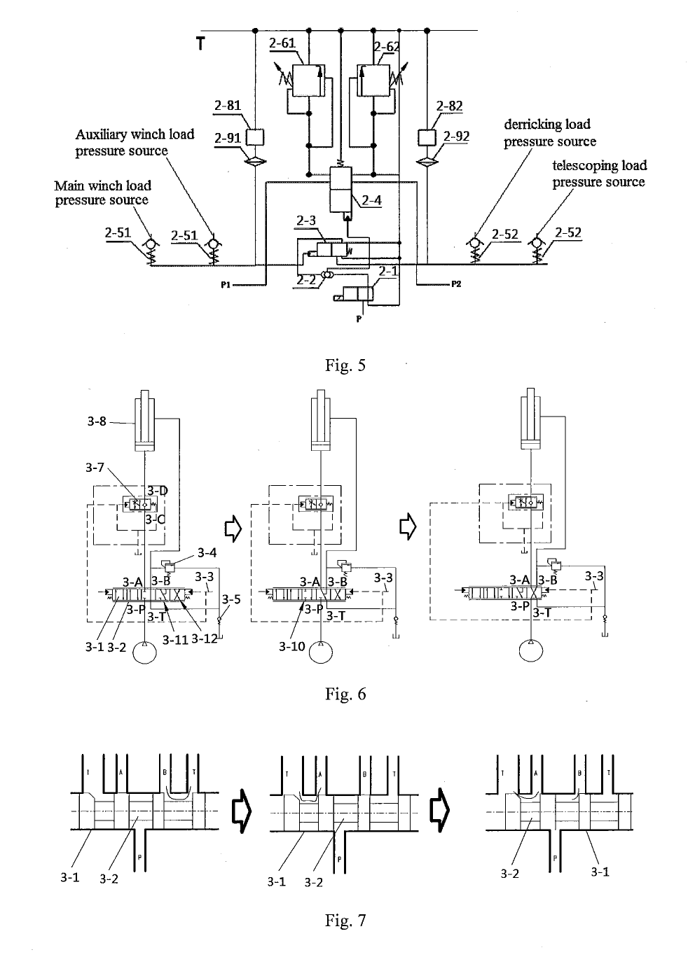

Referring to FIG. 5, at least one first check valve 2-51 is arranged on an oil line communicating the hydraulic operated port of the hydraulic operated reversing valve 2-3 and the first load pressure source. The oil inlet of each first check valve 2-51 communicates with one first load pressure source respectively, and the oil outlet of the first check valve 2-51 communicates with the hydraulic operated port of the hydraulic operated reversing valve 2-3. At least one second check valve 2-52 is arranged on an oil line communicating the oil inlet of the hydraulic operated reversing valve 2-3 and the second load pressure source. The oil inlet of each second check valve 2-52 communicates with one second load pressure source respectively, and the oil outlet of the second check valve 2-52 communicates with the oil inlet of the hydraulic operated reversing valve 2-3. It is still taken as an example that the first load pressure source includes the main winch load pressure source and the auxiliary winch load pressure source and that the second load pressure source includes the derricking load pressure source and the telescoping load pressure source, two first check valves 2-51 are arranged, the oil inlets of two first check valve 2-51 respectively communicate with the main winch load pressure source and the auxiliary winch load pressure source; two second check valves 2-52 are arranged, and the oil inlets of two second check valve 2-52 respectively communicate with the derricking load pressure source and the telescoping load pressure source.

Since the check valve cannot realize reflux, a first damping network 2-81 can be arranged on the oil return line between the first check valve 2-51 and the oil tank, and a second damping network 2-82 is arranged on the oil return line between the second check valve 2-52 and the oil tank for unloading in time. To filter impurities in the oil, filters can be further arranged in the oil return line to improve the safety of the system. Specifically, a first filter 2-91 is arranged between the first check valve 2-51 and the first damping network 2-81, and a second filter 2-92 is arranged between the second check valve 2-52 and the second damping network 2-82.

A confluence controlling method of the confluence control subsystem provided by any one of the aforementioned embodiments includes the following control process:

(1) Manual Confluence Control Mode

a control button can be set to control the energization and de-energization of the solenoid valve 2-1, so as to control confluence and non-confluence of two pumps. One specific implementation is as follows: when the control button is pressed down, the solenoid valve 2-1 is energized; when the control button pops up, the solenoid valve 2-1 is de-energized. The manual confluence control process will be specifically illustrated below.

When a control pressure output by the first load pressure source to the hydraulic operated port of the hydraulic operated reversing valve 2-3 is zero (for example, when the crane is not operated), and when the solenoid valve 2-1 is in a de-energized state, the hydraulic operated reversing valve 2-3 resets (namely being at a right position), a load oil source of the second load pressure source is interrupted from the shuttle valve 2-2 by the hydraulic operated reversing valve 2-3, meanwhile the solenoid valve 2-1 is at a right position, the control pressure oil of a control pressure source P is blocked and is interrupted from the shuttle valve 2-2 by the solenoid valve 2-1, the control pressure output by the shuttle valve 2-2 to the control port of the confluence valve 2-4 is zero, the confluence valve 2-4 is at an upper position, and the first main pump P1 and the second main pump P2 are in a confluence state at the moment, that is, the first main pump P1 and the second main pump P2 simultaneously supply oil for main winch, auxiliary winch, derricking mechanism and telescoping mechanism after confluence.

When the solenoid valve 2-1 is in an energized state, the solenoid valve 2-1 is at a left position, the control pressure oil of the control pressure source P communicates with the shuttle valve 2-2 through the solenoid valve 2-1, the control pressure output by the shuttle valve 2-2 enters the control port of the confluence valve 2-4, the confluence valve 2-4 is at a lower position, and the first main pump P1 and the second main pump P2 are cut off by the confluence valve 2-4, are in a non-confluence state at the moment and can only separately supply oil, that is, the first main pump P1 can supply oil to main and auxiliary winch, the second main pump P2 can supply oil to telescoping mechanism and derricking mechanism. Since the two pumps independently supply the oil, thereby generating no mutual influence on the performance.

By means of the manual confluence control mechanism of the two pumps, a confluence of the two pumps or separately independent work of the two pumps is realized by controlling the energization and de-energization of the solenoid valve 2-1 according to the demands of actual working conditions, for example, the single pump work in the case of winch micro moving, boom down, boom telescoping and other operations, so as to improve the micro moving performance and reduce the power consumption.

(2) Automatic Confluence Control Mode

When the composite action is carried out, for example, when the composite action of the main and auxiliary winch with derricking mechanism or the composite action of main and auxiliary winch with telescoping mechanism of the crane is carried out, the load pressure of the first load pressure source acts on the hydraulic operated port of the hydraulic operated reversing valve 2-3 to cause the hydraulic operated reversing valve 2-3 to work at a left position, the second load pressure source communicates with the shuttle valve 2-2 through the left position of the hydraulic operated reversing valve 2-3 at the moment. Since the other oil inlet of the shuttle valve 2-2 communicates with the solenoid valve 2-1 for direct oil return, the load pressure of the second load pressure source acts on the control port of the confluence valve 2-4 through the shuttle valve 2-2. When the load pressure of the second load pressure source is increased to be large enough to overcome a force of a reversing spring of the confluence valve 2-4, the confluence valve 2-4 reverses, the first main pump P1 and the second main pump P2 change from the confluence state into the non-confluence state. At this time, the first main pump P1 and the second main pump P2 respectively drive main/auxiliary winch and telescoping mechanism/derricking mechanism, the composite actions generate no mutual influence, and the composite actions are more reliable.

In the confluence control method, the first constant difference flow valve 2-61 and the second constant difference flow valve 2-62 can be arranged to form a small bypass flow to unload the pressure of the load feedback oil line in time at the end of the operation.

In the confluence control method, the first overflow valve 2-71 and the second overflow valve 2-72 can also be arranged to limit the maximum pressure of the load feedback oil line to maintain the working pressures of the hydraulic oil pumps. The confluence control subsystem provided by the present application can be applied to cranes.

In a schematic embodiment of the crane provided by the present application, the crane includes the confluence control subsystem in any one of the aforementioned embodiments.

By means of the descriptions of the aforementioned embodiments, it can be derived that the present application at least has the following advantages: automatic control and manual control of confluence of the two pumps can be realized by control logic composed of the solenoid valve, the hydraulic operated reversing valve and the shuttle valve, and thus the working rapidity and reliability of the crane are improved. During the composite action, when the load pressure difference is increased to a certain extent, the two pump confluence state can be automatically switched to the non-confluence state in which the two pumps independently supply oil and generate no influence on the performance, and the effect of the composite action is improved. By means of the manual confluence control of the two pumps, the two pumps can separately work according to the demands of actual working conditions, for example, the single pump work in the case of winch micro moving, boom down, boom telescoping and other operations, so as to improve the micro moving performance and reduce the power consumption.

According to yet another aspect of the present application, in order to solve the contradiction of synchronous improvement of smoothness and working efficiency of boom down, the crane hydraulic system of the present application can further include a crane derricking subsystem, which can be guaranteed that the derricking subsystem has good micro moving performance and smoothness during a small opening operation and has a higher down speed and higher working efficiency during a large opening operation. Meanwhile, when gravity down control mode is switched to power and gravity composite down control mode, the impact is small, the down process is smooth. The gravity down control mode and the gravity and power composite down control mode can be automatically switched. A reversing valve, an cylinder down control valve provided with the reversing valve and the crane derricking subsystem provided with the cylinder down control valve are convenient to operate.

Specific structures of various embodiments of the crane derricking subsystem will be specifically introduced below:

As shown in FIG. 6 to FIG. 7, the reversing valve provided by the embodiment of the present application includes a reversing valve body 3-1 and a reversing valve core 3-2. An oil inlet 3-P (or called a 3-P port), an oil return port 3-T (or call a 3-T port), a first oil port 3-A (or called a 3-A port) and a second oil port 3-B (or called a 3-B port) are provided on the reversing valve body 3-1.

When the reversing valve core 3-2 is at an initial position (a middle position as shown in FIG. 6) 3-10 in the reversing valve body 3-1, the oil passage between the oil inlet 3-P and the first oil port 3-A and the oil passage between the oil inlet 3-P and the second oil port 3-B are interrupted. The second oil port 3-B is communicated with the oil return port 3-T.

As shown in FIG. 6 to FIG. 7, when the reversing valve core 3-2 moves to a first position 3-11 in the reversing valve body 3-1, the oil passage between the oil inlet 3-P and the first oil port 3-A and the oil passage between the oil inlet 3-P and the second oil port 3-B are interrupted. The first oil port 3-A is connected with the second oil port 3-B in parallel and is communicated with the oil return port 3-T. Or, as shown in FIG. 6, when the reversing valve core 3-2 moves to the first position 3-11 in the reversing valve body 3-1, the oil passage between the oil inlet 3-P and the first oil port 3-A and the oil passage between the oil inlet 3-P and the second oil port 3-B are interrupted.

The first oil port 3-A is communicated with the oil return port 3-T, and the oil return port 3-T is connected with a branch oil passage unidirectionally communicated from the oil return port 3-T to the second oil port 3-B.

When the reversing valve core 3-2 moves to a second position 3-12 in the reversing valve body 3-1, the oil inlet 3-P is communicated with the second oil port 3-B, and the oil return port 3-T is communicated with the first oil port 3-A.

The distance between the second position 3-12 and the initial position 3-10 of the reversing valve core 3-2 is greater than the distance between the first position 3-11 and the initial position 3-10 of the reversing valve core 3-2.

The first position 3-11 of the reversing valve core 3-2 (or called a main valve rod) in the reversing valve provided by the embodiment of the present application is closer to the initial position 3-10 of the reversing valve core 3-2. The position of the reversing valve core 3-2 is adjusted to carry out the small opening operation. The reversing valve core 3-2 is moved from the initial position 3-10 to the first position 3-11 to control an derricking cylinder 3-8 (or the derricking subsystem provided with the derricking cylinder 3-8) in an initial down phase (or called a small opening operation phase). When the reversing valve core 3-2 moves to the first position 3-11 in the reversing valve body 3-1, a part of the hydraulic oil input from the first oil port 3-A can enter a rod cavity of the derricking cylinder 3-8 of the crane derricking subsystem employing the reversing valve through the second oil port 3-B, the other part (redundant hydraulic oil) of the hydraulic oil input from the first oil port 3-A can return through the oil return port 3-T. Since the rod cavity of the derricking cylinder 3-8 in the initial down phase does not need to communicate with an oil supply port of the oil pump through the oil inlet 3-P of the reversing valve in the present application, no pressure rise is generated in the rod cavity of the derricking cylinder 3-8, a piston rod of the derricking cylinder 3-8 downs by self gravity, so the down process is more stable. Meanwhile, the down speed of the piston rod of the derricking cylinder 3-8 is only related to the volume of the hydraulic oil input from the first oil port 3-A (or the volume of the hydraulic oil flowing out from the second oil port 3-B into the rod cavity of the derricking cylinder 3-8), the volume of the hydraulic oil input from the first oil port 3-A is related to the size of the opening of the first oil port 3-A and/or the size of the opening of a balance valve 3-7, the size of the opening of the first oil port 3-A and/or the size of the opening of the balance valve 3-7 is adjusted to effectively and stably control the down speed, and thus the micro moving performance is better. In addition, when the position of the reversing valve core 3-2 is adjusted, the reversing valve core 3-2 is moved from the first position 3-11 to the second position 3-12 during the large opening operation to control the derricking cylinder 3-8 (or the derricking subsystem provided with the derricking cylinder 3-8) in a power and gravity composite down phase (or called a large opening operation phase). When the reversing valve core 3-2 moves to the second position 3-12 in the reversing valve body 3-1, oil in the rodless cavity of the derricking cylinder 3-8 directly returns to the oil tank at the moment, however, the oil supply of the oil pump can directly enter the rod cavity of the derricking cylinder 3-8 through the oil inlet 3-P, the reversing valve core 3-2 and the second oil port 3-B of the reversing valve in the present application. The piston rod of the derricking cylinder 3-8 downs under the combined action of the self gravity and the pressure in the rod cavity. The down speed is related to the size of the opening of the first oil port 3-A, the size of the opening of the second oil port 3-B, the size of the opening of the balance valve 3-7 and the control pressure in the rod cavity of the derricking cylinder 3-8. During the large opening operation, the down speed is higher, and the working efficiency is higher.

As further optimization of any one of the technical solutions of the present application, the reversing valve further includes an overflow valve 3-4, the oil inlet of the overflow valve 3-4 is connected with the second oil port 3-B, the oil outlet of the overflow valve 3-4 is connected with the oil return port 3-T in parallel and is connected with the oil inlet of a check valve 3-5, and the oil outlet of the check valve 3-5 is communicated with the oil tank.

In the power and gravity composite down phase, with the increase of the control pressure, the reversing valve core of the reversing valve is at the second position 3-12, oil of the rodless cavity of the derricking cylinder 3-8 directly returns to the oil tank at the moment, however, the oil supply of the oil pump can directly enter the rod cavity of the derricking cylinder 3-8 through the reversing valve core. With the increase of the oil intake volume of the rod cavity, the pressure in the rod cavity reaches the control pressure of the overflow valve 3-4, and the overflow valve 3-4 overflows. The piston rod of the derricking cylinder 3-8 downs under the combined action of the self gravity and the pressure in the rod cavity. The down speed is related to the size of the opening of the balance valve 3-7 and the control pressure in the rod cavity, the down speed is high, and the working efficiency can be effectively improved. The overflow valve 3-4 can improve the safety of the derricking subsystem.

Due to the arrangement of the overflow valve 3-4, in a process of switching from the gravity down control mode to the power and gravity composite down control mode in the present application, the reversing valve bears small impact, and thus the down process is smooth.

As further optimization of any one of the technical solutions of the present application, the branch oil passage includes an oil replenishment overflow valve, the overflow valve 3-4 is replaced by the oil replenishment overflow valve. The oil inlet of the oil replenishment overflow valve is connected with the second oil port 3-B, the oil outlet of the oil replenishment overflow valve is connected with the oil return port 3-T in parallel and is connected with the oil inlet of the check valve 3-5, and the oil outlet of the check valve 3-5 is communicated with the oil tank.

When the oil replenishment overflow valve is in a first working state, the oil inlet of the oil replenishment overflow valve is communicated with the oil outlet of the oil replenishment overflow valve.

When the oil replenishment overflow valve is in a second working state, the oil passage from the oil outlet of the oil replenishment overflow valve to the oil inlet of the oil replenishment overflow valve is communicated, and the oil passage from the oil inlet of the oil replenishment overflow valve to the oil outlet of the oil replenishment overflow valve is interrupted.

When the reversing valve core is at the first position 3-11 for boom down, the oil in the rod cavity of the derricking cylinder 3-8 is replenished by the oil replenishment overflow valve, the oil in the rodless cavity of the derricking cylinder 3-8 directly returns to the oil tank and does not enter the rod cavity of the derricking cylinder 3-8. As further optimization of any one of the technical solutions of the present application, the check valve 3-5 is an oil replenishment check valve. The oil replenishment check valve can replenish oil for the rod cavity of the derricking cylinder 3-8 to improve the down speed of the piston rod of the derricking cylinder 3-8.

As further optimization of any one of the technical solutions of the present application, the reversing valve is a hydraulic operated reversing valve, and the hydraulic oil input from an external control oil source 3-3 into the reversing valve can drive the reversing valve core 3-2 to move from the initial position 3-10 to the first position 3-11, to move from the first position 3-11 to the initial position 3-10, to move from the first position 3-11 to the second position 3-12, and to move from the second position 3-12 to the first position 3-11 in the reversing valve body 3-1.

The hydraulic operated reversing valve has good reliability, and it is convenient for hydraulic control to make full use of the advantages of hydraulic energy of the crane derricking subsystem.

As further optimization of any one of the technical solutions of the present application, the reversing valve is a four-way five-position slide valve. When the reversing valve core 3-2 moves to a third position or to a fourth position in the reversing valve body 3-1, the oil inlet 3-P is communicated with the first oil port 3-A, and the oil return port 3-T is communicated with the second oil port 3-B.

The initial position 3-10 of the reversing valve core 3-2 in the reversing valve body 3-1 is the middle position of the reversing valve body 3-1, and the middle position is between the third position and the first position 3-11.

When the reversing valve core 3-2 of the reversing valve having the structure is at the third position or the fourth position, the oil supply of the oil pump can input hydraulic oil to the rodless cavity of the derricking cylinder 3-8 through the oil inlet 3-P and the first oil port 3-A to drive the piston rod of the derricking cylinder 3-8 to extend out to raise the boom, and the hydraulic oil in the rod cavity of the derricking cylinder 3-8 can return through the second oil port 3-B and the oil return port 3-T.

As further optimization of any one of the technical solutions of the present application, the first position 3-11 and the second position 3-12 are two adjacent positions among the positions where the reversing valve core 3-2 can move in the reversing valve body 3-1.

The reversing valve having the structure facilitates quick and smooth switch of the reversing valve core 3-2 between the first position 3-11 and the second position 3-12. The cylinder down control valve provided by the embodiment of the present application includes the balance valve 3-7 and the reversing valve provided by any one of the technical solutions of the present application, wherein:

a first oil port 3-C and a second oil port 3-D are provided in the balance valve 3-7, and the first oil port 3-C is connected with the first oil port 3-A of the reversing valve. When the balance valve 3-7 is in the first working state (an initial state), the oil passage from the first oil port 3-C to the second oil port 3-D is communicated, and the oil passage from the second oil port 3-D to the first oil port 3-C is interrupted. When the balance valve 3-7 is in the second working state (a down state of the piston rod of the derricking cylinder 3-8), the oil passage from the second oil port 3-D to the first oil port 3-C is communicated.

The cylinder down control valve is suitable for using the reversing valve provided by the present application to improve the micro moving performance of the derricking cylinder 3-8 connected with the same during the small opening operation, namely in the initial down phase, and the down speed during the large opening operation. When the balance valve 3-7 is in the first working state, the hydraulic oil in the rodless cavity of the derricking cylinder 3-8 is blocked by the balance valve 3-7 and cannot flow to the first oil port 3-A of the reversing valve through the balance valve 3-7, so the piston rod of the derricking cylinder 3-8 will not down; and when the balance valve 3-7 is in the second working state, the hydraulic oil in the rodless cavity of the derricking cylinder 3-8 can flow to the first oil port 3-A of the reversing valve through the balance valve 3-7, so the piston rod of the derricking cylinder 3-8 will down.

As further optimization of any one of the technical solutions of the present application, the balance valve 3-7 is a hydraulic operated balance valve, which includes a balance valve body and a balance valve core. When the balance valve core is at a first working position in the balance valve body, the balance valve 3-7 is in the first working state. When the balance valve core is at a second working position in the balance valve body, the balance valve 3-7 is in the second working state.

The hydraulic oil input from the external control oil source 3-3 to the balance valve 3-7 can drive the balance valve core to move from the first working position to the second working position in the balance valve body, and a reset spring between the balance valve core and the balance valve body can drive the balance valve core to move from the second working position to the first working position in the balance valve body.

The hydraulic operated balance valve has good reliability, and it is convenient for hydraulic control to make full use of the advantages of hydraulic energy of the derricking subsystem. The hydraulic operated balance valve and the hydraulic operated reversing valve can be controlled and driven by shared oil supply port of the oil pump.

The crane derricking subsystem provided by the embodiment of the present application includes the derricking cylinder 3-8 and the cylinder down control valve provided by any one of the technical solutions provided by the present application, wherein:

the rod cavity of the derricking cylinder 3-8 is connected with the second oil port 3-B of the reversing valve, and the rodless cavity of the derricking cylinder 3-8 is connected with the second oil port 3-D of the balance valve 3-7.

The working process of the cylinder down control valve provided by a preferred technical solution of the present application is as follows:

S1. Implementation of Gravity Down Control Mode:

The external control oil source 3-3 operates the main valve rod, namely the reversing valve core 3-2 to reverse, the balance valve 3-7 is opened at the same time under the action of the external control oil source 3-3. When the main valve rod is at the first position 3-11, a part of oil in the rodless cavity of the derricking cylinder 3-8 enters the rod cavity, and redundant oil returns to the oil tank. Since the rod cavity of the derricking cylinder is interrupted from oil supply of the oil pump, no pressure rise is generated in the rod cavity, and the piston rod downs by the self gravity. The down speed is only related to the size of the opening of the balance valve 3-7, so that the down process is stable, and the micro moving performance is good.

S2. Implementation of Power and Gravity Composite Down Control Mode:

With the increase of the control pressure, the reversing valve rod of the reversing valve is at the second position 3-12, the oil of the rodless cavity of the derricking cylinder 3-8 directly returns to the oil tank at the moment, however, the oil supply of the oil pump can directly enter the rod cavity of the derricking cylinder 3-8 through the reversing valve rod. With the increase of the oil intake volume of the rod cavity, the pressure in the rod cavity reaches the control pressure of the overflow valve 3-4, and the overflow valve 3-4 overflows. The derricking cylinder 3-8 downs under the combined action of the self gravity and the pressure in the rod cavity. The down speed is related to the size of the opening of the balance valve 3-7 and the control pressure in the rod cavity. The down speed is high, and the working efficiency can be effectively improved.

As shown in FIG. 6 and FIG. 7, the 3-A port in the reversing valve provided by the present application is connected with the rodless cavity of the derricking cylinder 3-8, and the 3-B port is connected with the rod cavity of the derricking cylinder 3-8. At the middle position, the 3-P port does not communicate with the 3-A port, and the 3-B port communicates with the 3-T port; when the reversing valve core 3-2 is at the first position 3-11, the 3-P port does not communicate with the 3-B port, the 3-A port communicates with the 3-T port, the oil returns through the rodless cavity, and the boom downs by the gravity; and when the reversing valve core 3-2 is at the second position 3-12, the 3-P port communicates with the 3-B port, the 3-A port communicates with the 3-T port, at this time, the rod cavity of the derricking cylinder is supplied oil by the oil pump to gradually establish the pressure, and the piston rod downs under the combined action of the gravity and the power.

In summary, the technical effects that can be produced by the preferred technical solution of the present application at least include:

1. It can be guaranteed that the derricking subsystem has good micro moving performance and smoothness during the small opening operation and a higher down speed during the large opening operation, and thus the working efficiency is improved.

2. When the gravity down control mode is switched to the power and gravity composite down control mode, the impact is small, and the down process is smooth.

3. The gravity down control mode and the gravity and power composite control mode are automatically switched, so that the operation is convenient.

According to yet another aspect of the present application, in order to solve the problems that the composite action of the telescoping mechanism and the auxiliary winch of the crane cannot be carried out and that unloading is insufficient, the crane hydraulic system of the present application can further include a composite action control subsystem. The composite action control subsystem is a new composite action control solution. A control solenoid valve is singly arranged in each control cavity of two proportional reversing valves, the energization and de-energization states of each, control solenoid valve are controlled, and output oil passages of the handle are selected, so that the present application can not only singly control the action of each executive element, but also simultaneously control the actions of the two executive elements, and thus the control of the composite action is realized. Moreover, since the oil return port of each control solenoid valve communicates with the oil tank in a serial mode, the unloading speed is high, and no action residue is generated. In addition, there is no cross connection between the control cavities of the proportional reversing valves and the oil passages connected with the control solenoid valves, therefore, on one hand, the malfunction caused by oil mixing will not occur, and on the other hand, the control solenoid valves can also be integrated on the proportional reversing valve, which reduces pipeline connection, and thus the cost is reduced. Specific structures of various embodiments of the composite action control subsystem will be specifically introduced below:

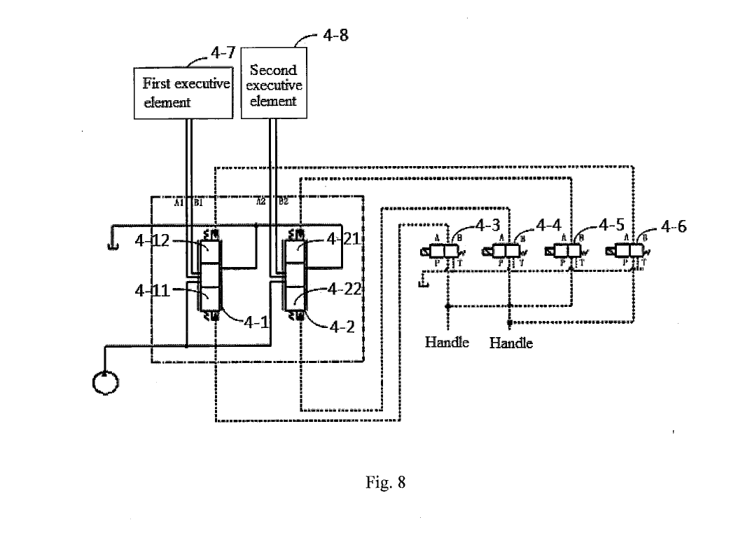

FIG. 8 is a schematic diagram of one embodiment of the composite action control subsystem in the present application. As shown in FIG. 8, the system includes: a first proportional reversing valve 4-1, a second proportional reversing valve 4-2, a first control solenoid valve 4-3, a second control solenoid valve 4-4, a third control solenoid valve 4-5 and a fourth control solenoid valve 4-6, wherein:

the first control oil port of the first proportional reversing valve 4-1 communicates with the working oil port, namely the A port, of the first control solenoid valve 4-3, the second control oil port of the first proportional reversing valve 4-1 communicates with the working oil port of the fourth control solenoid valve 4-6, the working oil port of the first proportional reversing valve 4-1 communicates with a first executive element 4-7, the oil inlet of the first proportional reversing valve 4-1 communicates with the oil pump, and the oil outlet of the first proportional reversing valve 4-1 communicates with the oil tank; the first control oil port of the second proportional reversing valve 4-2 communicates with the working oil port of the second control solenoid valve 4-4, the second control oil port of the second proportional reversing valve 4-2 communicates with the working oil port of the third control solenoid valve 4-5, the working oil port of the second proportional reversing valve 4-2 communicates with a second executive element 4-8, the oil inlet of the second proportional reversing valve 4-2 communicates with the oil pump, and the oil outlet of the second proportional reversing valve 4-2 communicates with the oil tank; the oil inlets of the first control solenoid valve 4-3 and the third control solenoid valve 4-5 communicate with a first output oil passage of the handle, and the oil inlets of the second control solenoid valve 4-4 and the fourth control solenoid valve 4-6 communicate with a second output oil passage of the handle; and the oil return ports of the first control solenoid valve 4-3, the second control solenoid valve 4-4, the third control solenoid valve 4-5 and the fourth control solenoid valve 4-6 communicate with the oil tank. The first executive element 4-7 and the second executive element 4-8 can be selected according to actual application. For example, the working oil ports of the abovementioned control solenoid valves can be an A port or a B port of each control solenoid valve. For example, the working oil port of the first proportional reversing valve can be an A1 port or a B1 port, and for example, the working oil port of the second proportional reversing valve can be an A2 port or a B2 port.

In the embodiment, the control solenoid valve is singly arranged corresponding to each control cavity of the two proportional reversing valves, the, energization and de-energization states of each control solenoid valve are controlled, and the output oil passages of the handle are selected, so that the present application can not only singly control the action of each executive element, but also can simultaneously control the actions of the two executive elements, and thus the control of the composite action is realized. Moreover, since the oil return port of each control solenoid valve communicates with the oil tank in the serial mode, the unloading speed is high, and no action residue is generated. In addition, there is no cross connection between the oil passages of the control cavities of the proportional reversing valves and the control solenoid valves, therefore, on one hand, the malfunction phenomenon caused by oil mixing will not occur, and on the other hand, the control solenoid valves can also be integrated on the proportional reversing valves, which reduces the pipeline connection, and thus the cost is reduced.

In another application embodiment, the working oil port of the first proportional reversing valve 4-1 includes a first working oil port and a second working oil port, the first executive element 4-7 is a motor, the first working oil port of the first proportional reversing valve 4-1 communicates with the first oil port of the motor, and the second working oil port of the first proportional reversing valve 4-1 communicates with the second oil port of the motor; and the working oil port of the second proportional reversing valve 4-2 includes a first working oil port and a second working oil port, the second executive element 4-8 is a telescopic cylinder, the first working oil port of the second proportional reversing valve 4-2 communicates with the rodless cavity of the telescopic cylinder, and the second working oil port of the second proportional reversing valve 4-2 communicates with the rod cavity of the telescopic cylinder.

In the embodiment, when the hydraulic oil controlled by the handle enters the control cavity of the first proportional reversing valve 4-1, the first proportional reversing valve 4-1 reverses to drive the motor to execute a corresponding action, for example, the motor can drive the auxiliary winch to raise or down the hook in the case of forward rotation or reverse rotation. When the hydraulic oil controlled by the handle enters the control cavity of the first proportional reversing valve 4-1, the second proportional reversing valve 4-2 reverses to drive the telescopic cylinder to execute a corresponding action, for example, when the hydraulic oil enters the rodless cavity of the telescopic cylinder, the boom can be driven to extend, and when the hydraulic oil enters the rod cavity of the telescopic cylinder, the boom can be driven to retract. The energization and de-energization states of the control solenoid valves are respectively controlled, and the actions of the motor and the telescopic cylinder can be controlled respectively or simultaneously, and thus the composite action of hook up and down by the auxiliary winch and boom telescoping is further controlled.

In the embodiment as shown in FIG. 8, when the energization and de-energization states of each control solenoid valve are different, and the selections on the output oil passages of the handle are different, the action execution conditions of the two executive elements are different as well, which will be respectively illustrated below. In one embodiment of the composite action control subsystem in the present application, as shown in FIG. 8, when the first control solenoid valve 4-3, the second control solenoid valve 4-4, the third control solenoid valve 4-5 and the fourth control solenoid valve 4-6 are all de-energized, and when the handle supplies oil to the first output oil passage, the oil inlet of the first control solenoid valve 4-3 communicates with the working oil port of the first control solenoid valve 4-3, the hydraulic oil controlled by the handle enters the first control cavity 4-11 of the first proportional reversing valve 4-1 through the oil inlet and the working oil port of the first control solenoid valve 4-3, and the first proportional reversing valve 4-1 is switched from communicating the oil inlet with the first working oil port A1 to communicating the oil inlet with the second working oil port B1, in order to drive the first executive element 4-7 to execute a first action. In this case, the oil inlet of the third control solenoid valve 4-5 communicates with the working oil port of the third control solenoid valve 4-5, the hydraulic oil enters the first control cavity 4-21 of the second proportional reversing valve 4-2 through the oil inlet and the working oil port of the third control solenoid valve 4-5, and the second proportional reversing valve 4-2 is switched from communicating the oil inlet with the second working oil port B2 to communicating the oil inlet with the first working oil port A2, in order to drive the second executive element 4-8 to execute a second action.

In the embodiment, composite control that the first executive element 4-7 executes the first action and the second executive element 4-8 executes the second action can be realized. When the first executive element 4-7 is the motor and the second executive element 4-8 is the telescopic cylinder, the motor will be switched from forward rotation into reverse rotation (the first action) to drive the auxiliary winch to lower the hook, the hydraulic oil enters the rodless cavity of the telescopic cylinder, and the telescopic cylinder extends out (the second action) to drive the boom to extend. In addition, the oil inlet of the second control solenoid valve 4-4 communicates with the working oil port of the second control solenoid valve 4-4, and the oil inlet of the fourth control solenoid valve 4-6 communicates with the working oil port of the fourth control solenoid valve 4-6. However, since the handle supplies oil to the first output oil passage, the hydraulic oil controlled by the handle cannot enter the second control cavity 4-12 of the first proportional reversing valve 4-1 or the second control cavity 4-22 of the second proportional reversing valve 4-2.

In another embodiment of the composite action control subsystem in the present application, when the first control solenoid valve 4-3, the second control solenoid valve 4-4, the third control solenoid valve 4-5 and the fourth control solenoid valve 4-6 are all de-energized, and when the handle supplies oil to the second output oil passage, the oil inlet of the fourth control solenoid valve 4-6 communicates with the working oil port of the fourth control solenoid valve 4-6, the hydraulic oil enters the second control cavity 4-12 of the first proportional reversing valve 4-1 through the oil inlet and the working oil port of the fourth control solenoid valve 4-6, and the first proportional reversing valve 4-1 is switched from communicating the oil inlet with the second working oil port B1 to communicating the oil inlet with the first working oil port A1, in order to drive the first executive element 4-7 to execute a third action. In this case, the oil inlet of the second control solenoid valve 4-4 communicates with the working oil port of the second control solenoid valve 4-4, the hydraulic oil enters the second control cavity 4-22 of the second proportional reversing valve 4-2 through the oil inlet and the working oil port of the second control solenoid valve 4-4, and the second proportional reversing valve 4-2 is switched from communicating the oil inlet with the first working oil port A2 to communicating the oil inlet with the second working oil port B2, in order to drive the second executive element 4-8 to execute a fourth action.

In the embodiment, composite control that the first executive element 4-7 executes the third action and the second executive element 4-8 executes the fourth action can be realized. When the first executive element 4-7 is the motor and the second executive element 4-8 is the telescopic cylinder, the motor will be switched from reverse rotation into forward rotation (the third action) to drive the auxiliary winch to raise the hook, the hydraulic oil enters the rod cavity of the telescopic cylinder, and the telescopic cylinder retracts (the fourth action) to drive the boom to retract. In addition, the oil inlet of the first control solenoid valve 4-3 communicates with the working oil port of the first control solenoid valve 4-3, and the oil inlet of the third control solenoid valve 4-5 communicates with the working oil port of the third control solenoid valve 4-5. However, since the handle supplies oil to the second output oil passage, the hydraulic oil controlled by the handle cannot enter the first control cavity 4-11 of the of the first proportional reversing valve 4-1 or the first control cavity 4-21 of the second proportional reversing valve 4-2.

In another embodiment of the composite action control subsystem in the present application, when the first control solenoid valve 4-3 and the fourth control solenoid valve 4-6 are de-energized, and the second control solenoid valve 4-4 and the third control solenoid valve 4-5 are energized, two situations are included:

in one situation, the handle supplies oil to the first output oil passage, the oil inlet of the first control solenoid valve 4-3 communicates with the working oil port of the first control solenoid valve 4-3, the hydraulic oil enters the first control cavity 4-11 of the first proportional reversing valve 4-1 through the oil inlet and the working oil port of the first control solenoid valve 4-3, and the first proportional reversing valve 4-1 is switched from communicating the oil inlet with the first working oil port A1 to communicating the oil inlet with the second working oil port B1, in order to drive the first executive element 4-7 to execute the first action;

in another situation, the handle supplies oil to the second output oil passage, the oil inlet of the fourth control solenoid valve 4-6 communicates with the working oil port of the fourth control solenoid valve 4-6, the hydraulic oil enters the second control cavity 4-12 of the first proportional reversing valve 4-1 through the oil inlet and the working oil port of the fourth control solenoid valve 4-6, and the first proportional reversing valve 4-1 is switched from communicating the oil inlet with the second working oil port B1 to communicating the oil inlet with the first working oil port A1, in order to drive the first executive element 4-7 to execute the third action. In the embodiment, the working oil port of the second control solenoid valve 4-4 communicates with the oil return port, the working oil port of the third control solenoid valve 4-5 communicates with the oil return port, and the second executive element 4-8 cannot execute the action. By controlling the output oil passages of the handle, the first executive element 4-7 can be singly controlled to act. Specifically, when the first executive element 4-7 is the motor, the auxiliary winch can be singly controlled to raise and lower the hook.

In another embodiment of the composite action control subsystem in the present application, when the second control solenoid valve 4-4 and the third control solenoid valve 4-5 are de-energized, and the first control solenoid valve 4-3 and the fourth control solenoid valve 4-6 are energized, two situations are also included: in one situation, the handle supplies oil to the first output oil passage, the oil inlet of the third control solenoid valve 4-5 communicates with the working oil port of the third control solenoid valve 4-5, the hydraulic oil enters the first control cavity 4-21 of the second proportional reversing valve 4-2 through the oil inlet and the working oil port of the third control solenoid valve 4-5, and the second proportional reversing valve 4-2 is switched from communicating the oil inlet with the second working oil port B2 to communicating the oil inlet with the first working oil port A2, in order to drive the second executive element 4-8 to execute the second action;

in another situation, the handle supplies oil to the second output oil passage, the oil inlet of the second control solenoid valve 4-4 communicates with the working oil port of the second control solenoid valve 4-4, the hydraulic oil enters the second control cavity 4-22 of the second proportional reversing valve 4-2 through the oil inlet and the working oil port of the second control solenoid valve 4-4, and the second proportional reversing valve 4-2 is switched from communicating the oil inlet with the first working oil port A2 to communicating the oil inlet with the second working oil port B2, in order to drive the second executive element 4-8 to execute the fourth action. In the embodiment, the working oil port of the first control solenoid valve 4-3 communicates with the oil return port, and the working oil port of the fourth control solenoid valve 4-6 communicates with the oil return port. The first executive element 4-7 cannot execute the action. By controlling the output oil passages of the handle, the second executive element 4-8 can be singly controlled to act. Specifically, when the second executive element 4-8 is the telescopic cylinder, the boom telescoping can be singly controlled.

It should be noted that, when the first executive element 4-7 is the motor and the second executive element 4-8 is the telescopic cylinder, although the first action and the fourth action are respectively described as reverse rotation and forward rotation, and the second action and the fourth action are described as extension and retraction above, those skilled in the art can understand that, vice versa, as long as the boom extension and the hook down by the auxiliary winch can be simultaneously realized, and the boom retraction and the hook up by the auxiliary winch can be simultaneously realized.

In yet another embodiment of the composite action control subsystem in the present application, when the first control solenoid valve 4-3, the second control solenoid valve 4-4, the third control solenoid valve 4-5 and the fourth control solenoid valve 4-6 are all energized, respective working oil ports of the first control solenoid valve 4-3, the second control solenoid valve 4-4, the third control solenoid valve 4-5 and the fourth control solenoid valve 4-6 communicate with respective oil return ports. In the embodiment, each control solenoid valve is energized, the control cavities of the proportional reversing valves directly communicate with the oil tank through the working oil ports and the oil return ports of the control solenoid valves, so that the unloading speed is high, and no action residue is generated.

In practical application, control on the composite action of the first executive element and the second executive element, single control on the action of the first executive element and single control on the action of the second executive element can be switched by a three-position rocker switch.

Based on the composite action control subsystem of any one of the aforementioned embodiments, in one embodiment of a composite action control method in the present application, the method includes: When the first control solenoid valve 4-3, the second control solenoid valve 4-4, the third control solenoid valve 4-5 and the fourth control solenoid valve 4-6 are all de-energized, controlling the handle to supply oil to the first output oil passage, so that the hydraulic oil simultaneously enters the first control cavity 4-11 of the first proportional reversing valve 4-1 and the first control cavity 4-21 of the second proportional reversing valve 4-2, switching the first proportional reversing valve 4-1 from communicating the oil inlet with the first working oil port A1 to communicating the oil inlet with the second working oil port B1, and switching the second proportional reversing valve 4-2 from communicating the oil inlet with the second working oil port B2 to communicating the oil inlet with the first working oil port A2, in order to drive the first executive element 4-7 to execute a first action, and drive the second executive element 4-8 to execute a second action at the same time; and when the first control solenoid valve 4-3, the second control solenoid valve 4-4, the third control solenoid valve 4-5 and the fourth control solenoid valve 4-6 are all de-energized, controlling the handle to supply oil to the second output oil passage, so that the hydraulic oil simultaneously enters the second control cavity 4-12 of the first proportional reversing valve 4-1 and the second control cavity 4-22 of the second proportional reversing valve 4-2, switching the first proportional reversing valve 4-1 from communicating the oil inlet with the second working oil port B1 to communicating the oil inlet with the first working oil port A1, and switching the second proportional reversing valve 4-2 from communicating the oil inlet with the first working oil port A2 to communicating the oil inlet with the second working oil port B2, in order to drive the first executive element 4-7 to execute a third action, and drive the second executive element 4-8 to execute a fourth action at the same time. According to the control method in the embodiment, the composite action in which the first executive element 4-7 executes the first action and the second executive element 4-8 executes the second action, and the composite action in which the first executive element 4-7 executes the third action and the second executive element 4-8 executes the fourth action can be controlled.

In another embodiment of the composite action control method in the present application, the method further includes:

when the first control solenoid valve 4-3 and the fourth control solenoid valve 4-6 are de-energized, and the second control solenoid valve 4-4 and the third control solenoid valve 4-5 are energized, controlling the handle to supply oil to the first output oil passage, so that the hydraulic oil enters the first control cavity 4-11 of the first proportional reversing valve 4-1, switching the first proportional reversing valve 4-1 from communicating the oil inlet with the first working oil port A1 to communicating the oil inlet with the second working oil port B1, in order to drive the first executive element 4-7 to execute the first action; controlling the handle to supply oil to the second output oil passage, so that the hydraulic oil enters the second control cavity 4-12 of the first proportional reversing valve 4-1, and switching the first proportional reversing valve 4-1 from communicating the oil inlet with the second working oil port B1 to communicating the oil inlet with the first working oil port A1, in order to drive the first executive element 4-7 to execute a third action;

when the second control solenoid valve 4-4 and the third control solenoid valve 4-5 are de-energized, and the first control solenoid valve 4-3 and the fourth control solenoid valve 4-6 are energized, controlling the handle to supply oil to the first output oil passage, so that the hydraulic oil enters the first control cavity 4-21 of the second proportional reversing valve 4-2, and switching the second proportional reversing valve 4-2 from communicating the oil inlet with the second working oil port B2 to communicating the oil inlet with the first working oil port A2, in order to drive the second executive element 4-8 to execute the second action; and controlling the handle to supply oil to the second output oil passage, so that the hydraulic oil enters the second control cavity 4-22 of the second proportional reversing valve 4-2, and switching the second proportional reversing valve 4-2 from communicating the oil inlet with the first working oil port A2 to communicating the oil inlet with the second working oil port B2, in order to drive the second executive element 4-8 to execute a fourth action.

According to the control method in the embodiment, the single control that the first executive element 4-7 executes the first action and the third action, and the single control that the second executive element 4-8 executes the second action and the fourth action can be realized.

The composite action control subsystem provided by the aforementioned embodiments of the present application can be applied to a crane.

In one embodiment of the crane in the present application, the crane can include the composite action control subsystem provided by any one of the aforementioned embodiments.

The specific structure and technical effects of multiple embodiments of the load sensing subsystem, the confluence control subsystem, the crane derricking subsystem and the composite action control subsystem have been separately introduced above, in other embodiments of the present application, any two, three or four of the aforementioned four subsystems can be combined, and the obtained new crane hydraulic systems shall fall within the protection scope of the present application. The foregoing descriptions are merely preferred embodiments of the present application, it should be noted that those of ordinary skill in the art can also make multiple improvements and modifications without departing from the principle of the present application, and all these improvements and modifications shall fall within the protection scope of the present application.

1-32. (canceled)

33. A crane hydraulic system comprising a load sensing subsystem wherein the load sensing subsystem comprises:
a variable pump, a variable pump oil inlet line], a load feedback line, an oil return line and a pressure compensator; wherein,
the pressure compensator is provided with an oil inlet, an oil outlet, a first control oil port, a second control oil port and a control spring;
the oil inlet communicates with the variable pump oil inlet line, the oil outlet communicates with the oil return line, the first control oil port communicates with the load feedback line, and the second control oil port communicates with the variable pump oil inlet line; and
the control spring and the first control oil port are located on a same end of the pressure compensator, and a set pressure of the control spring is greater than a pressure difference of the variable pump.

34. The crane hydraulic system of claim 33, further comprising a confluence control subsystem, wherein the confluence control subsystem comprises:
a solenoid valve, a shuttle valve, a hydraulic operated reversing valve and a confluence valve;
an oil inlet of the solenoid valve communicates with a control pressure source, a first oil inlet of the shuttle valve communicates with a working oil port of the hydraulic operated reversing valve, a second oil inlet of the shuttle valve communicates with a working oil port of the solenoid valve, an oil outlet of the shuttle valve communicates with a control port of the confluence valve, a hydraulic operated port of the hydraulic operated reversing valve communicates with at least one first load pressure source, an oil inlet of the hydraulic operated reversing valve communicates with at least one second load pressure source, a first oil port of the confluence valve communicates with a first main pump, and a second oil port of the confluence valve communicates with a second main pump; after the solenoid valve is energized, the oil inlet of the solenoid valve communicates with the working oil port, and after the solenoid valve is de-energized, the working oil port of the solenoid valve communicates with an oil return port;
after the hydraulic operated reversing valve reverses through the hydraulic operated port, the oil inlet of the hydraulic operated reversing valve communicates with the working oil port, and after the hydraulic operated reversing valve resets, the working oil port of the hydraulic operated reversing valve communicates with the oil return port.

35. The crane hydraulic system of claim 34, wherein a first shuttle valve is arranged on an oil line communicating a hydraulic operated port of the hydraulic operated reversing valve and the first load pressure source, the oil inlet of the first shuttle valve communicates with the first load pressure source, and an oil outlet of the first shuttle valve communicates with the hydraulic operated port of the hydraulic operated reversing valve; and
a second shuttle valve is arranged on an oil line communicating the oil inlet of the hydraulic operated reversing valve and the second load pressure source, the oil inlet of the second shuttle valve communicates with the second load pressure source, and the oil outlet of the second shuttle valve communicates with the oil inlet of the hydraulic operated reversing valve.

36. The crane hydraulic system of claim 34, wherein at least one first check valve is arranged on an oil line communicating the hydraulic operated port of the hydraulic operated reversing valve and the first load pressure source, the oil inlet of each first check valve communicates with one first load pressure source respectively, and the oil outlet of the first check valve communicates with the hydraulic operated port of the hydraulic operated reversing valve; and
at least one second check valve is arranged on an oil line communicating the oil inlet of the hydraulic operated reversing valve and the second load pressure source, the oil inlet of each second check valve communicates with one second load pressure source respectively, and the oil outlet of the second check valve communicates with the oil inlet of the hydraulic operated reversing valve.

37. The crane hydraulic system of claim 34, wherein the confluence control subsystem further comprises:
a first constant difference flow valve and a second constant difference flow valve;
oil inlet of the hydraulic operated reversing valve communicates with a third oil port of the confluence valve, and the oil outlet of the first constant difference flow valve communicates with an oil tank; and
the oil inlet of the second constant difference flow valve communicates with a fourth oil port of the confluence valve, and the oil outlet of the second constant difference flow valve communicates with the oil tank.

38. The crane hydraulic system of claim 34, wherein the confluence control subsystem further comprises:
a first overflow valve and a second overflow valve;
the oil inlet of the first overflow valve communicates with a third oil port of the confluence valve, and the oil outlet of the first overflow valve communicates with an oil tank; and
the oil inlet of the second overflow valve communicates with a fourth oil port of the confluence valve, and the oil outlet of the second overflow valve communicates with the oil tank.

39. The crane hydraulic system of claim 36, wherein a first damping network is arranged on an oil return line between the first check valve and the oil tank, and a second damping network is arranged on an oil return line between the second check valve and the oil tank.

40. The crane hydraulic system of claim 33, further comprising a crane derricking subsystem, wherein the crane derricking subsystem comprises an derricking cylinder and an cylinder down control valve, the cylinder down control valve comprises a balance valve and a reversing valve, wherein:
a first oil port and a second oil port are provided in the balance valve, and the first oil port is connected with an oil port of the reversing valve;
when the balance valve is in a first working state, an oil passage from the first oil port to the second oil port is communicated, and an oil passage from the second oil port to the first oil port is interrupted;
when the balance valve is in a second working state, the oil passage from the second oil port to the first oil port is communicated; and
a rod cavity of the derricking cylinder is in communication with another oil port of the reversing valve, and a rodless cavity of the derricking cylinder is in communication with the second oil port of the balance valve.

41. The crane hydraulic system of claim 40, wherein the reversing valve comprises a reversing valve body and a reversing valve core; and
the reversing valve body is provided with an oil inlet, an oil return port, a first oil port and a second oil port;
wherein when the reversing valve core is at an initial position in the reversing valve body, an oil passage between the oil inlet and the first oil port and an oil passage between the oil inlet and the second oil port are interrupted;
the second oil port is in communication with the oil return port;
when the reversing valve core moves to a first position in the reversing valve body, the oil passage between the oil inlet and the first oil port and the oil passage between the oil inlet and the second oil port are interrupted, wherein the first oil port is connected with the second oil port in parallel and is in communication with the oil return port, or the first oil port is in communication with the oil return port, and the oil return port is in communication with a branch oil passage unidirectionally communicated from the oil return port to the second oil port;
when the reversing valve core moves to a second position in the reversing valve body, the oil inlet on the reversing valve body is in communication with the second oil port, and the oil return port is in communication with the first oil port; and
a distance between the second position of the reversing valve core and an initial position of the reversing valve core is greater than a distance between the first position of the reversing valve core and the initial position of the reversing valve core.

42. The crane hydraulic system of claim 41, wherein the cylinder down control valve further comprises an overflow valve, the oil inlet of the overflow valve is connected with the second oil port, the oil outlet of the overflow valve is connected with the oil return port in parallel and is connected with the oil inlet of a check valve, and the oil outlet of the check valve is in communication with the oil tank.

43. The crane hydraulic system of claim 41, wherein the branch oil passage comprises an oil replenishment overflow valve, the oil inlet of the oil replenishment overflow valve is connected with the second oil port, the oil outlet of the oil replenishment overflow valve is connected with the oil return port in parallel and is connected with the oil inlet of the check valve, and the oil outlet of the check valve is in communication with the oil tank;
when the oil replenishment overflow valve is in a first working state, the oil inlet of the oil replenishment overflow valve is in communication with the oil outlet of the oil replenishment overflow valve; and
when the oil replenishment overflow valve is in a second working state, an oil passage from the oil outlet of the oil replenishment overflow valve to the oil inlet of the oil replenishment overflow valve is communicated, and an oil passage from the oil inlet of the oil replenishment overflow valve to the oil outlet of the oil replenishment overflow valve is interrupted.

44. The crane hydraulic system of claim 33, further comprising a composite action control subsystem, wherein the composite action control subsystem comprises:
a first proportional reversing valve, a second proportional reversing valve, a first control solenoid valve, a second control solenoid valve, a third control solenoid valve and a fourth control solenoid valve;
wherein the first control oil port of the first proportional reversing valve communicates with the working oil port of the first control solenoid valve, the second control oil port of the first proportional reversing valve communicates with the working oil port of the fourth control solenoid valve, the working oil port of the first proportional reversing valve communicates with a first executive element, the oil inlet of the first proportional reversing valve communicates with a oil pump, and the oil outlet of the first proportional reversing valve communicates with the oil tank;
the first control oil port of the second proportional reversing valve communicates with the working oil port of the second control solenoid valve, the second control oil port of the second proportional reversing valve communicates with the working oil port of the third control solenoid valve, the working oil port of the second proportional reversing valve communicates with a second executive element, the oil inlet of the second proportional reversing valve communicates with the oil pump, and the oil outlet of the second proportional reversing valve communicates with the oil tank;
the oil inlets of the first control solenoid valve and the third control solenoid valve communicate with a first output oil passage of the handle, and the oil inlets of the second control solenoid valve and the fourth control solenoid valve communicate with a second output oil passage of the handle; and
the oil return ports of the first control solenoid valve, the second control solenoid valve, the third control solenoid valve and the fourth control solenoid valve communicate with the oil tank.

45. The crane hydraulic system of claim 44, wherein when the first control solenoid valve, the second control solenoid valve, the third control solenoid valve and the fourth control solenoid valve are all de-energized, and when the handle supplies oil to the first output oil passage, the oil inlet of the first control solenoid valve communicates with the working oil port, and the hydraulic oil enters the first control cavity of the first proportional reversing valve through the oil inlet and the working oil port of the first control solenoid valve, in order to drive the first executive element to execute a first action; and
the oil inlet of the third control solenoid valve communicates with the working oil port, and the hydraulic oil enters the first control cavity of the second proportional reversing valve through the oil inlet and the working oil port of the third control solenoid valve, in order to drive the second executive element to execute a second action.

46. The crane hydraulic system of claim 44, wherein when the first control solenoid valve, the second control solenoid valve, the third control solenoid valve and the fourth control solenoid valve are all de-energized, and when the handle supplies oil to the second output oil passage, the oil inlet of the fourth control solenoid valve communicates with the working oil port, and the hydraulic oil enters the second control cavity of the first proportional reversing valve through the oil inlet and the working oil port of the fourth control solenoid valve, in order to drive the first executive element to execute a third action; and
the oil inlet of the second control solenoid valve communicates with the working oil port, and the hydraulic oil enters the second control cavity of the second proportional reversing valve through the oil inlet and the working oil port of the second control solenoid valve, in order to drive the second executive element to execute a fourth action.

47. The crane hydraulic system of claim 44, wherein when the first control solenoid valve and the fourth control solenoid valve are de-energized, and the second control solenoid valve and the third control solenoid valve are energized, and when the handle supplies oil to the first output oil passage, the oil inlet of the first control solenoid valve communicates with the working oil port, and the hydraulic oil enters the first control cavity of the first proportional reversing valve through the oil inlet and the working oil port of the first control solenoid valve, in order to drive the first executive element to execute the first action; and
when the first control solenoid valve and the fourth control solenoid valve are de-energized, and the second control solenoid valve and the third control solenoid valve are energized, and when the handle supplies oil to the second output oil passage, the oil inlet of the first control solenoid valve communicates with the working oil port, the oil inlet of the fourth control solenoid valve communicates with the working oil port, and the hydraulic oil enters the second control cavity of the first proportional reversing valve through the oil inlet and the working oil port of the fourth control solenoid valve, in order to drive the first executive element to execute the third action.

47. The crane hydraulic system of claim 44, wherein when the second control solenoid valve and the third control solenoid valve are de-energized, and the first control solenoid valve and the fourth control solenoid valve are energized, and when the handle supplies oil to the first output oil passage, the oil inlet of the third control solenoid valve communicates with the working oil port, and the hydraulic oil enters the first control cavity of the second proportional reversing valve through the oil inlet and the working oil port of the third control solenoid valve, in order to drive the second executive element to execute the second action; and
when the second control solenoid valve and the third control solenoid valve are de-energized, and the first control solenoid valve and the fourth control solenoid valve are energized, and when the handle supplies oil to the second output oil passage, the oil inlet of the second control solenoid valve communicates with the working oil port, and the hydraulic oil enters the second control cavity of the second proportional reversing valve through the oil inlet and the working oil port of the second control solenoid valve, in order to drive the second executive element to execute the fourth action.

48. The crane hydraulic system of claim 44, wherein when the first control solenoid valve, the second control solenoid valve, the third control solenoid valve and the fourth control solenoid valve are all energized, the working oil port of each among the first control solenoid valve, the second control solenoid valve, the third control solenoid valve and the fourth control solenoid valve communicates with corresponding oil return port.

49. A controlling method of the crane hydraulic system of claim 33, comprising the following steps:
setting an opening pressure of the pressure compensator of the load sensing subsystem connected with a winch system greater than a difference between a variable pump pressure and a load pressure of the load sensing subsystem; and
starting the winch system.

50. The control method of claim 49, wherein the setting an opening pressure of the pressure compensator of the load sensing subsystem connected with a winch system greater than a difference between a variable pump pressure and a load pressure of the load sensing subsystem comprises:
communicating the oil inlet of the pressure compensator with the variable pump oil inlet line of the load sensing subsystem, communicating the oil outlet of the pressure compensator with the oil return line of the load sensing subsystem, communicating the first control oil port of the pressure compensator with the load feedback line of the load sensing subsystem, and communicating the second control oil port of the pressure compensator with the variable pump oil inlet line, wherein the control spring and the first control oil port are located on the same end of the pressure compensator, and the set pressure of the control spring is greater than the pressure difference of the variable pump.

51. A controlling method of the crane hydraulic system of claim 34, comprising the following control process:
when a control pressure output by the first load pressure source to the hydraulic operated port of the hydraulic operated reversing valve is zero, and when the solenoid valve is de-energized, the hydraulic operated reversing valve resets, a load oil source of the second load pressure source is interrupted from the shuttle valve by the hydraulic operated reversing valve, meanwhile a control pressure oil of a control pressure source is interrupted from the shuttle valve by the solenoid valve, the control pressure output by the shuttle valve to the control port of the confluence valve is zero, the confluence valve is at an upper position, and the first main pump and the second main pump are in a confluence state at the moment;
when the solenoid valve is energized, the control pressure oil of the control pressure source communicates with the shuttle valve through the solenoid valve, the control pressure oil output by the shuttle valve enters the control port of the confluence valve, the confluence valve is at a lower position, and the first main pump and the second main pump are cut off by the confluence valve and are in a non-confluence state at the moment; and
when a composite action is carried out, the load pressure of the first load pressure source acts on the hydraulic operated port of the hydraulic operated reversing valve to cause the hydraulic operated reversing valve to work at a left position, the load pressure oil of the second load pressure source communicates with the shuttle valve through the left position of the hydraulic operated reversing valve and acts on the control port of the confluence valve through the shuttle valve at the moment, when the load pressure of the second load pressure source is increased to be large enough to overcome a force of a reversing spring of the confluence valve, the confluence valve reverses, and the first main pump and the second main pump change from the confluence state into the non-confluence state.

52. A controlling method of the crane hydraulic system of claim 44, comprising:
when the first control solenoid valve, the second control solenoid valve, the third control solenoid valve and the fourth control solenoid valve are all de-energized, controlling the handle to supply oil to the first output oil passage, so that the hydraulic oil simultaneously enters the first control cavity of the first proportional reversing valve and the first control cavity of the second proportional reversing valve, in order to drive the first executive element to execute a first action, and drive the second executive element to execute a second action at the same time; and
when the first control solenoid valve, the second control solenoid valve, the third control solenoid valve and the fourth control solenoid valve are all de-energized, controlling the handle to supply oil to the second output oil passage, so that the hydraulic oil simultaneously enters the second control cavity of the first proportional reversing valve and the second control cavity of the second proportional reversing valve, in order to drive the first executive element to execute a third action, and drive the second executive element to execute a fourth action at the same time.

53. The control method of claim 52, further comprising:
when the first control solenoid valve and the fourth control solenoid valve are de-energized, and the second control solenoid valve and the third control solenoid valve are energized, controlling the handle to supply oil to the first output oil passage, so that the hydraulic oil enters the first control cavity of the first proportional reversing valve, in order to drive the first executive clement to execute the first action; controlling the handle to supply oil to the second output oil passage, so that the hydraulic oil enters the second control cavity of the first proportional reversing valve, in order to drive the first executive element to execute a third action;
when the second control solenoid valve and the third control solenoid valve are de-energized, and the first control solenoid valve and the fourth control solenoid valve are energized, controlling the handle to supply oil to the first output oil passage, so that the hydraulic oil enters the first control cavity of the second proportional reversing valve, in order to drive the second executive element to execute the second action; and controlling the handle to supply oil to the second output oil passage, so that the hydraulic oil enters the second control cavity of the second proportional reversing valve, in order to drive the second executive clement to execute a fourth action.
